(19) United States
(12) Patent Application Publication
(10) Pub. No.: US 2020/0346164 A1
(43) Pub. Date: Nov. 5, 2020

(54) METHOD AND DEVICE FOR OBTAINING WATER FROM AMBIENT AIR

(71) Applicant: AQUAHARA TECHNOLOGY GmbH, Gilching (DE)

(72) Inventor: Philippe VERPLANCKE, Gilching (DE)

(21) Appl. No.: 16/763,892

(22) PCT Filed: Nov. 15, 2018
(86) PCT No.: PCT/EP2018/081361

§ 371 Date: May 13, 2020

(30) Foreign Application Priority Data
Nov. 16, 2017 (DE) 10 2017 127 012.4

(51) Int. Cl. B01D 53/26; B01D 53/28; B01D 5/00; B01D 53/18; B01D 53/14; E03B 3/28

(52) U.S. Cl. CPC B01D 53/263; B01D 53/28; B01D 5/0003; B01D 5/0051; B01D 5/006; B01D 2252/10; B01D 5/0087; B01D 53/185; B01D 53/1425; B01D 53/1493; E03B 3/28; B01D 5/0075

(57) ABSTRACT

A method for obtaining water from ambient air, wherein the method contains at least the following method steps: contacting the ambient air with at least one liquid absorbent for absorbing at least a part of the water contained in the ambient air; conveying an absorbent diluted by the absorbed water to a first heat exchanger; transferring the diluted absorbent into at least one desorption device. Therein, water desorbed in the desorption device is conveyed to the first heat exchanger, wherein cooling of the desorbed water is effected by means of the diluted absorbent by means of the first heat exchanger. Furthermore, disclosed is a device for obtaining water from ambient air.

### FIELD

The present invention relates to a method for obtaining water from ambient air. Furthermore, the invention relates to a device for obtaining water from ambient air.

### BACKGROUND

Such methods and devices for obtaining water from ambient air are known in a great plurality. In particular, corresponding absorption methods are known from the air dehumidification technology. Therein, humidity from the air is absorbed in so-called liquid drying agents, for example in concentrated, hygroscopic salt solutions. A highly hygroscopic salt is e.g. lithium chloride. Subsequently, the water is partially again removed from the salt solution by heating, vacuum distillation, reverse osmosis or similar methods such that the solution can again be employed for dehumidifying the air. This method is for example industrially offered by the company Kathabar (see http://www.kathabar.com/liquid-desiccant/systen-features-benefits). Further systems, which are for example offered on the market under the designation “Ducool”, conduct process air through a honeycombed structure, which is soaked with the salt solution, by means of a blower such that water vapor from the air is there absorbed from the cool and concentrated salt solution. A separate regeneration airflow is sent through the honeycomb structure soaked with the warm salt solution. Therein, a part of the water again evaporates from the salt solution and the water vapor is discharged from the regeneration air. The above presented methods can be used for the construction of an atmospheric water generator, wherein the aim of these methods is the air dehumidification and not obtaining liquid water from the ambient air. From WO 2009/135618 A1, a method and a device for obtaining water from the ambient air are known.

All of the above mentioned methods and devices disadvantageously have a very high energy input, in particular of electrical energy. If one would supply the known atmospheric water generators exclusively with regenerative energy, for example in desert regions, this would imply the necessity of a very large area of photovoltaic modules with correspondingly high cost per liter of the obtained water. Therefore, heat from the following sources was employed heretofore for the operation of the known plants with evaporation devices: combustion of fossil fuels, with the known disadvantages for the environment; conventional thermal solar modules, often even with vacuum tubes, to be able to achieve correspondingly high temperatures and with correspondingly high plant cost; as well as condensation heat in the method of the so-called mechanical vapor recompression, for which much electrical energy is in turn required.

DE 10 2013 013 214 A1 also describes a device for obtaining water from atmospheric air with a flowable sorbent for sorption of the water. In an evaporator, the absorbed water is withdrawn from the thus diluted sorbent by means of evaporation. Therein, the diluted sorbent is applied with negative pressure in the evaporator. Therein, at least one heat exchanger as a pre-heating unit is arranged in the sorption path. However, it is disadvantageous in this prior art that always an expensive, since corrosion-resistant, heat exchanger is used here as the pre-heating unit for the diluted sorbent.

The heat arising in the condensation of the water subsequent to the evaporation/distillation of the salt solution has to be discharged into the environment. Thereto, separate cooling devices arranged in the line system after the condenser are employed in conventional plants, which in turn increase the plant cost.

### BRIEF SUMMARY

Therefore, it is the object of the present invention to provide a generic method and a generic device, which can be simpler and more inexpensively operated and produced, respectively, and require less energy input than known methods and devices.

A generic method according to the features of claim 1 as well as a device according to the features of claim 14 serve for solving these objects. Advantageous configurations with convenient developments of the invention are specified in the respective dependent claims, wherein advantageous configurations of the method are to be regarded as advantageous configurations of the device and vice versa.

A method according to the invention for obtaining water from ambient air includes at least the following method steps: supplying water vapor generated from a diluted liquid absorbent by at least one evaporator to a condenser, wherein the condenser includes at least one heat exchanger for condensing the water vapor; conveying at least one cooling medium to the heat exchanger and conveying the heated cooling medium exiting from the condenser to at least one device for large-area contacting the cooling medium with the ambient air for cooling the cooling medium by means of the ambient air. By the method according to the invention, cooling of the condenser without additional separate cooling devices is first ensured. In addition, the heated cooling medium is again supplied to the device for large-area contacting the cooling medium with the ambient air for cooling. Thereby, the method can be simply and inexpensively operated and requires a lower energy input than known methods. In advantageous configurations of the method according to the invention, the steps of supplying and conveying the cooling medium are performed multiple times with formation of a cooling circuit. In addition, there is the possibility that performing the steps of supplying and conveying the cooling medium multiple times is affected in a predetermined time interval, in particular in the daytime. Therein, the cooling of the cooling medium can be affected by spraying the cooling medium in the ambient air and/or by means of passing the ambient air through the device having a large surface.

Therein, any type of liquids with low vapor pressure is understood by the term “cooling medium”.

In further advantageous configurations of the method according to the invention, the cooling medium is the absorbent diluted by the absorbed water of the ambient air, wherein at least a part of the diluted absorbent is supplied to the evaporator with or without interposition of a reservoir in at least one separate flow circuit. Advantageously, both the water absorbed from the ambient air can be supplied to the evaporator and the condenser can be cooled on the other hand by means of a solution. Thereby, the method according to the invention can be extremely inexpensively operated. Therein, the liquid absorbent can be at least one hygroscopic salt solution or a mixture of different hygroscopic salt solutions. Therein, any type of liquid drying agents is understood by the term “liquid absorbent”, which result in an absorption of at least a part of the water contained in the ambient air in the absorbent. The liquid absorbents can in particular be salt solutions such as for example a lithium chloride solution. Active conveyance for example by means of at least one pump, but also conveyance by means of gravity is understood by the term “conveying”. However, it is also possible that the cooling medium is a liquid with low vapor pressure, in particular an oil. This has the advantage that the heat exchanger arranged within the condenser can also be composed of not corrosion-resistant and thereby usually more inexpensive material. If the diluted absorbent is not used as the cooling medium, thus, it is conveyed in a flow circuit separate from the flow circuit of the diluted absorbent. Thus, undesired mixtures and contaminations, respectively, of the different media can be reliably avoided.

In further advantageous configurations of the method according to the invention, the diluted absorbent is supplied to the evaporator with or without interposition of a reservoir. Thereby, there is the possibility that the method according to the invention provides conveyance to and reception and storage of the diluted absorbent obtained from the ambient air in the at least one reservoir. Concentration of the diluted absorbent with obtainment of a concentrated absorbent is effected on the evaporation structure of the evaporator, wherein the concentrated absorbent can be supplied to device being in contact with the ambient air for large-area contacting the cooling medium with the ambient air—with or without interposition of a heat exchanger. Therein, the concentrated absorbent can be buffered in the reservoir and be supplied to the device, which then serves as an absorption structure, in a predetermined time interval, in particular at night. Advantageously, this configuration of the method according to the invention utilizes the different day and night temperatures for optimizing the method sequence, since the temperature difference between absorption and desorption is increased with increasing day-night temperature difference and thereby the water yield per volume unit of the salt solution increases and a lower salt concentration in the absorbent is required, respectively. However, both processes (absorption and desorption) can also be proceed in alternating or simultaneous manner in the daytime. Via the outflow and inflow of the diluted and/or concentrated absorbent to and from the reservoir as a buffer, the absorption and desorption cycle can be controlled.

In a further advantageous configuration of the method according to the invention, the cooling medium is transferred into at least one buffer downstream of the device for large-area contacting the ambient air with the cooling medium before conveying to the condenser. Thereby, the possibility of an individual, in particular time-dependent, control of the amounts of the cooling medium supplied to the condenser advantageously arises.

In a further advantageous configuration of the method according to the invention, at least a part of the desorbed water is removed from the system circuit via at least one suitable device in flow direction after the condenser. Thereby, it is avoided on the one hand that the water amount in the system continuously increases by the continuous condensation of water in the desorption device. In order that the water circuit does not overflow, at least a part of this desorbed water is removed continuously or at predetermined points of time.

The present invention further relates to a device for obtaining water from ambient air, wherein the device comprises at least one evaporator for generating water vapor from a diluted absorbent, at least one condenser in operative connection with the evaporator, wherein the condenser includes at least one heat exchanger for condensation of the water vapor, includes at least one conveying device for conveying a cooling medium to the heat exchanger for cooling the condenser and means for conveying the heated cooling medium exiting from the condenser to at least one device for large-area contacting the cooling medium with the ambient air for cooling the cooling medium by means of the ambient air. By the device according to the invention, cooling of the condenser without additional external and separately arranged cooling devices is first possible. In addition, the heated cooling medium is again supplied to the device for large-area contacting the cooling medium with the ambient air for cooling. Thereby, a very simple and inexpensive construction of the device arises on the one hand, which also requires a relatively low energy input for operation on the other hand. Therein, any type of liquids with low vapor pressure is again understood by the term “cooling medium”.

In further advantageous configurations of the device according to the invention, the cooling medium is a diluted absorption solution, wherein the device according to the invention comprises at least one separate flow circuit to the evaporator with or without interposition of a reservoir and at least a part of the diluted absorption solution is supplied to the evaporator. The absorption solution can again be at least one hygroscopic salt solution or a mixture of different hygroscopic salt solutions. By the device according to the invention, advantageously, both the water absorbed from the ambient air can be supplied to the evaporator and the condenser can be cooled on the other hand by means of a solution, namely the diluted absorption solution. Thereby, the device according to the invention can be extremely inexpensively operated. Therein, any type of liquid drying agents is understood by the term “liquid absorbent”, which result in absorption of at least a part of the water contained in the ambient air in the absorbent. The liquid absorbent can for example be lithium chloride solutions. However, there is also the possibility that the cooling medium is a liquid with low vapor pressure, in particular an oil. This in turn has the advantage that the heat exchanger arranged within the condenser can also be composed of not corrosion-resistant and thereby usually more inexpensive material. If the diluted absorbent is not used as the cooling medium, thus, the device according to the invention includes at least one flow circuit separate from a flow circuit of the diluted absorbent for conveying the cooling medium. Thus, undesired mixtures and contaminations, respectively, of the different media can be reliably avoided.

In a further advantageous configuration of the device according to the invention, it includes at least one buffer for the cooling medium downstream of the device for large-area contacting the cooling medium with the ambient air. Thereby, the possibility of an individual, in particular time-dependent, control of the amounts of the cooling medium supplied to the condenser advantageously arises.

In further advantageous configurations of the device according to the invention, the device comprises means for controlling conveyance of the cooling medium in a predetermined time interval. Thereby, the operation of the device according to the invention can be individually controlled and be adapted to the parameters to be encountered on site.

In a further advantageous configuration of the device according to the invention, the device includes at least one spray nozzle and/or at least one honeycomb structure and/or at least one absorption structure and/or at least one plate structure for large-area contacting the cooling medium with the ambient air. Other structures are also conceivable, wherein they also have to provide a cooling surface and/or absorption surface as large as possible on the one hand.

In a further advantageous configuration of the device according to the invention, the device includes at least one device for removing the desorbed water from the system circuit. Therein, this removing device can be arranged after the condenser. By the at least partial removal of the desorbed water, it is ensured that the water circuit in the device does not overflow on the one hand, the removed water can be used for other purposes on the other hand. Therein, the removal of the desorbed water can be affected continuously or at preset points of time.

### BRIEF DESCRIPTION OF THE FIGURES

Further features of the invention are apparent from the claims, the embodiments as well as based on the drawings. The features and feature combinations mentioned above in the description as well as the features and feature combinations mentioned below in the embodiments are usable not only in the respectively specified combination, but also in other combinations without departing from the scope of the invention.

FIG. 1 is a schematic representation of a device according to the invention according to a first embodiment.

FIG. 2 is a schematic representation of a device according to the invention according to a second embodiment.

### DETAILED DESCRIPTION

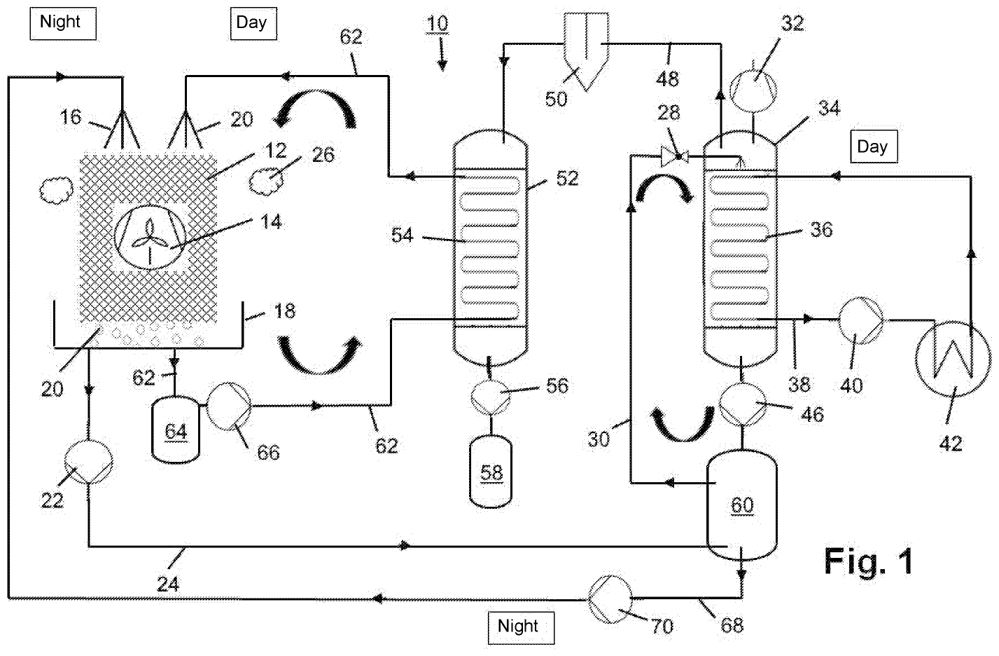

FIG. 1 shows a schematic representation of a device 10 for obtaining water from ambient air 26. In the illustrated first embodiment, the device 10 includes a device (not illustrated) for outputting a liquid absorbent 16 onto an absorption structure 12. In the illustrated first embodiment, the absorption structure 12 also represents a device for large-area contacting a cooling medium, as is explained in detail below. For applying or spreading the liquid absorbent 16, a suitable pipe system with corresponding openings or valves or comparative spraying devices can be used. Therein, the liquid absorbent 16 is in particular distributed over an entire upper surface of the absorption structure 12 and thus soaks the absorption structure 12. The absorbent 16 subsequently slowly flows into the lower areas of the absorption structure 12, where it again flows out of it and is again collected by a trough system 18. One recognizes that the absorption structure 12 is formed honeycombed in the illustrated embodiment. Thereby, a very large surface arises, on which an absorption of at least a part of the water contained in the ambient air can be affected. Therein, the absorption of the water from the ambient air 26 is affected in the liquid absorbent 16, wherein the condensation heat arising thereby is immediately again emitted from the absorbent 16 to the ambient air 26 by the large surface of the honeycombed absorption structure 12. By the absorption of water from the ambient air 26, the liquid absorbent 16 is diluted and exits from the absorption structure 12 as diluted absorbent 20.

In the illustrated embodiment, the ambient air 26 is large-area contacted with the liquid absorbent 16. The liquid absorbent 16 is at least one hygroscopic salt solution or a mixture of different salt solutions. For example, a concentrated lithium chloride solution is used. Therein, the absorption structure 12 can be formed such that it can be arranged outdoors and can be passed by natural wind. Thereby, energy and plant cost can be saved since additional blowers are not required. However, if the natural wind conditions should not allow a sufficiently large flow of the ambient air 26 through the absorption structure 12, corresponding auxiliary means, such as for example blowers 14, can of course be additionally employed. The absorption structure 12 is to be selected with suitable permeability, suitable strength and suitable size. Such structures are for example available in a robust cardboard design protected against decomposition in very inexpensive manner and are nowadays for example used in the evaporative cooling of henhouses.

In the further description of the embodiment, the straight lines provided with arrows represent liquid lines, such as for example pipes or hoses, wherein the liquids used in the device flow in arrow direction. The pumping devices required thereto are known to the expert and only represented in one variant of implementation in the figure.

Among other things, it is a conveying device or pump 22 for conveying the absorbent 20 diluted by the absorbed water to an evaporator 34. One recognizes that a reservoir 60 for buffering the diluted absorbent 20 is arranged in the line path between the pump 22 and the evaporator 34. However, there is also the possibility that the diluted absorbent is directly supplied to the evaporator 34. A valve 28 is arranged in flow direction after the reservoir 60.

In addition, a heat exchanger 36 is arranged in the evaporator 34, which is connected to a solar module 42 via a line system 38 in liquid conducting manner. Other heat transferring systems can also be arranged in the evaporator 34. A heat transfer liquid moved by means of a pump 40 circulates in the line system 38. Hereto, the solar module 42 comprises a line system, which can be composed of an ideally corrosion-resistant material, in particular plastic. Heating and/or evaporation of at least a part of the water contained in the diluted absorbent 20 heated by the solar module 42 are affected by means of the heat exchanger 36.

The evaporator 34 is connected to the reservoir 60 via a line system 44 in liquid conducting manner. The reservoir 60 also serves for receiving the now concentrated absorbent. Hereto, the reservoir 60 is for example formed as a layer storage such that mixture of the diluted absorbent 20 with the now concentrated absorbent 16 does not occur. It is indicated by the semi-circular arrows that a circuit for the diluted and later concentrated absorbent, respectively, results by this construction. Via passage of the circuit including reservoir 60 and evaporator 34 multiple times, there results a high yield of water vapor as well as a further concentrated absorbent. Per circulation, the yield of water vapor from the absorbent can be ca. 5 to 10%. The mentioned circuit is in particular performed in the daytime since the solar module 42 can here be particularly efficiently operated. At night, that is at usually lower temperatures, the concentrated absorbent can then again be introduced into the absorption structure 12 via a pump 70 and a line system 68 arranged between the reservoir 60 and the absorption structure 12 in liquid conducting manner such that water can again be absorbed by the absorbent 16 and thereby the diluted absorbent 20 arises, which is again collected in the collecting container 18.

Furthermore, one recognizes that the evaporator 34 is connected to a condenser 52 via a line system 48 in medium conducting manner. In addition, a droplet separator 50 is arranged between the evaporator 34 and the condenser 52. The droplet separator 50 reliably separates the particles such as for example salt particles arisen in the evaporator 34 and carried along by the arisen water vapor still before entry of the water vapor in the condenser 52. The condenser 52 includes a heat exchanger 54, which serves for cooling the condenser 52 and thereby also for increase of the condensation of the introduced water vapor. Other heat transferring systems can also be arranged in the condenser 52. One recognizes that the heat exchanger 54 is connected to a line system 62. The diluted absorbent 20 is at least partially passed through the heat exchanger 54 via the line system 62 and a pump 66 arranged therein. After exit from the condenser 52, the diluted absorbent 20 is again conducted via the absorption structure 12. Since the temperature of the diluted absorbent 20 is considerably lower than the temperature within the condenser 52, cooling of the condenser 52 is affected via the heat exchanger 54. The diluted absorbent 20 heated after exit from the condenser 52 is then again cooled via the absorption structure 12. In addition, there is the possibility that the absorbent 20 absorbs further amounts of water from the ambient air 26. In the illustrated embodiment, a collecting container 64 is formed before the pump 66. Thereby, in particular the amounts of diluted absorbent 20, which are supplied to the condenser 52, can be regulated. Furthermore, one recognizes that the diluted absorbent 20 can circulate multiple times in the line system 62 and the absorption structure 12. This is indicated in FIG. 1 by the corresponding semi-circular arrows.

This cooling operation is predominantly performed in the daytime according to the shown embodiment, since here the temperature difference between the diluted absorbent 20 and the water obtained by the condenser 52 is highest.

The condensed water is conducted out from the condenser 52 and received in a downstream collecting container 58. The removal of the water can be controlled via a pump 56. The thus obtained water can be removed from the collecting container 58 by means of suitable devices.

Furthermore, one recognizes that a negative pressure for assisting the supply of the evaporated water to the condenser 52 and for assisting the evaporation of the heated, diluted absorbent 20 is provided within the evaporator 34 as well as within the condenser 52 by means of a negative pressure device 32.

In addition, the device 10 comprises means for controlling conveyance of the liquid, diluted absorbent or the cooling medium 20 in a predetermined time interval to predetermined elements of the device 10. Thereby, the water obtaining process can be optimally adapted to the environmental conditions, in particular the temperature conditions. For example, both the absorption and the desorption of the water from the ambient air 26 can proceed in the daytime in alternating or simultaneous manner. All of the mentioned pumps would then run at the same time. In order to avoid high heat losses in this case, at least one heat exchanger for heat recovery can then be arranged in the flow and return of the absorbent 16, 20 in the absorption circuit. For example, there is the possibility of arranging a heat exchanger in the line system between the evaporator 34 and a reservoir for receiving and storing the concentrated absorbent coming from the evaporator. This heat exchanger would then for example be in operative connection with a further line system, which originates from a second reservoir for receiving the relatively cool diluted absorbent (not illustrated). Thereby, a relatively inexpensive approach of pre-heating the diluted absorbent to be introduced into the evaporator arises.

In order to produce drinking water from the desorbed water, a filter and disinfecting process and a mineralizing process, respectively, optionally have to be arranged downstream. These processes correspond to the prior art. It is pointed out that the concentrated absorbents and salt solutions, respectively, proposed in the present invention already have a highly disinfecting effect. For convenience, the mineralization of the water obtained from the air could occur in that the water is passed through a gravel bed.

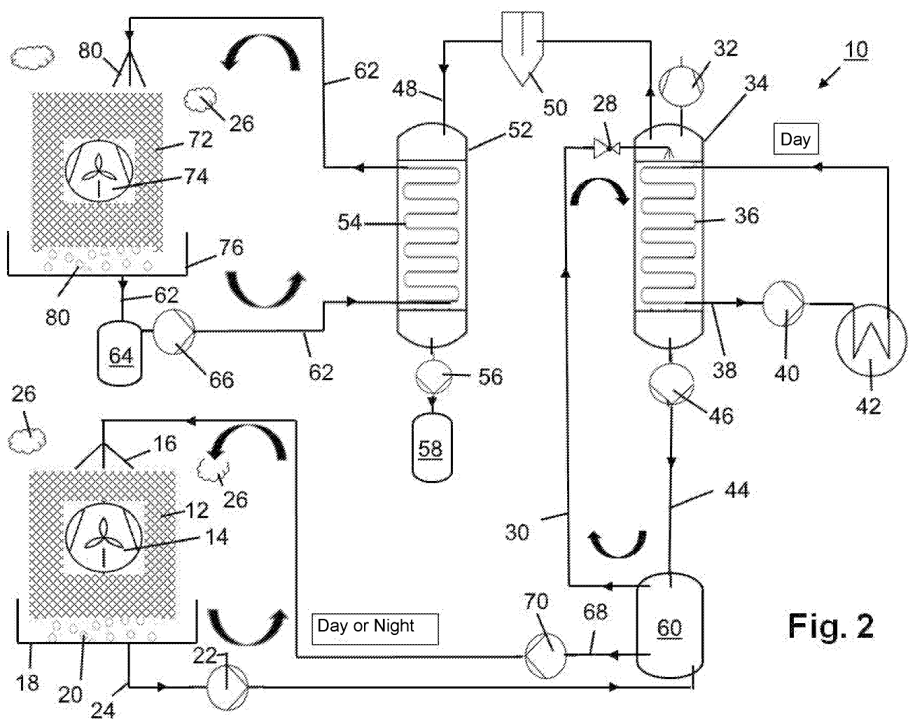

FIG. 2 shows a schematic representation of a device 10 for obtaining water from ambient air 26 according to a second embodiment. Basically, the device 10 according to the second embodiment is formed as the device 10 according to the first embodiment. Insofar, identical reference characters in FIG. 2 denote the corresponding identical features in FIG. 1. In contrast to the first embodiment illustrated in FIG. 1, the device 10 here comprises two separated circuits for a cooling medium 80 and the diluted liquid and the concentrated absorbent 20, 16. This is in particular caused in that the cooling medium 80 is an oil in the illustrated embodiment, which is not to mix with the diluted absorbent 20. One recognizes that the diluted absorbent 20 is again collected in a collecting system 18 and is diluted with water from the ambient air 26 by spraying or passing the concentrated liquid absorbent via the absorption structure 12. The diluted absorbent is again supplied to the evaporator 34 with interposition of the reservoir 60 via the line system 24 and the pump 22 arranged therein. The diluted absorbent 20 is heated and evaporated in the evaporator 34 via the heat exchanger 36 formed in the evaporator 34, which is arranged in the line system 38 of the solar module 42. The concentrated absorbent 16 is again supplied to the absorption structure 16 via a line system 44 and a pump 46 arranged therein with interposition of the reservoir 60 and the line system 68 originating therefrom and the pump 70 arranged therein.

A second circuit, namely a cooling circuit for the condenser 52 is formed by the line system 62 and the pump 66 arranged therein as well as the heat exchanger 54 arranged in the condenser 52. One recognizes that the cooling medium 80 is used for cooling the condenser 52 in the mentioned circuit and by flowing through the heat exchanger 54. The cooling medium 80, namely an oil in the illustrated embodiment, is again passed via the device 72 via the line system 62, wherein the cooling medium 80 is cooled by means of the ambient air 26 in the device 72. For intensifying this effect, a blower 74 is arranged in the area of the device 72 in the illustrated embodiment. The thus cooled cooling medium 80 is collected in a collecting container 76 and, if required, supplied to the line system 62. In the line system 62, a collecting container 64 is again arranged, wherein the amount of cooling medium 80, which is to be supplied to the heat exchanger 54, can be controlled by the collecting container 64 among other things.

It is to be clarified at this place that the term “water vapor” describes the gaseous aggregate state of water and not a mixture of air and water droplets.

1-22. (canceled)

23. A method for obtaining water from ambient air, wherein the method comprises:
supplying water vapor generated from a diluted liquid absorbent by at least one evaporator to a condenser, wherein the condenser includes at least one heat exchanger for condensing the water vapor;
conveying at least one cooling medium to the at least one heat exchanger; and
conveying a heated cooling medium exiting from the condenser to at least one device for large-area contacting of the heated cooling medium with the ambient air for cooling the heated cooling medium by means of the ambient air.

24. The method according to claim 23, wherein the steps of supplying the water vapor, conveying the at least one cooling medium and conveying the heated cooling medium are performed multiple times with formation of a cooling circuit.

25. The method according to claim 24, wherein performing the steps of supplying the water vapor, conveying the at least one cooling medium and conveying the heated cooling medium multiple times is effected in a predetermined time interval, in particular in the daytime.

26. The method according to claim 23, wherein the cooling of the heated cooling medium is effected by spraying the heated cooling medium in the ambient air and/or by means of passing the ambient air through the at least one device.

27. The method according to claim 23, wherein the at least one cooling medium is the diluted liquid absorbent diluted by absorbed water of the ambient air, wherein at least a part of the diluted liquid absorbent is supplied to the at least one evaporator in at least one separate flow circuit with or without interposition of a reservoir.

28. The method according to claim 27, wherein the diluted liquid absorbent is at least one hygroscopic salt solution or a mixture of different hygroscopic salt solutions.

29. The method according to claim 23, wherein the at least one cooling medium is a liquid with low vapor pressure, in particular an oil.

30. The method according to claim 29, wherein the at least one cooling medium is conveyed in a flow circuit separate from a flow circuit of the diluted liquid absorbent.

31. The method according to claim 30, wherein the diluted liquid absorbent is supplied to the at least one evaporator with or without interposition of a reservoir.

32. The method according to claim 27, wherein a concentration of the diluted liquid absorbent is effected in the at least one evaporator with obtaining a concentrated absorbent, wherein the concentrated absorbent is supplied to the at least one device for large-area contacting of the concentrated absorbent with the ambient air, wherein the at least one device serves as an absorption structure.

33. The method according to claim 32, wherein the concentrated absorbent is buffered in the reservoir and is supplied to the at least one device with or without interposition of a heat exchanger in a predetermined time interval, in particular at night.

34. The method according to claim 23, wherein the heated cooling medium is transferred into at least one buffer downstream of the at least one device before conveying to the condenser.

35. The method according to claim 23, wherein at least a part of desorbed water is removed from a system circuit via at least one suitable device in flow direction after the condenser.

36. A device for obtaining water from ambient air comprising:
at least one evaporator for generating water vapor from a diluted liquid absorbent;
at least one condenser in operative connection with the at least one evaporator, wherein the at least one condenser includes at least one heat exchanger for condensation of the water vapor;
at least one conveying device for conveying a cooling medium to the at least one heat exchanger for cooling the at least one condenser; and
means for conveying heated cooling medium exiting from the at least one condenser to at least one device for large-area contacting of the heated cooling medium with the ambient air for cooling the heated cooling medium by means of the ambient air.

37. The device according to claim 36, wherein the cooling medium is a liquid absorbent diluted by absorbed water of the ambient air and the device includes at least one separate flow circuit to the at least one evaporator with or without interposition of a reservoir, wherein at least a part of the diluted liquid absorbent is supplied to the at least one evaporator.

38. The device according to claim 37, wherein the liquid absorbent is at least one hygroscopic salt solution or a mixture of different hygroscopic salt solutions.

39. The device according to claim 36, wherein the cooling medium is a liquid with low vapor pressure, in particular an oil.

40. The device according to claim 39, wherein the device includes at least one flow circuit separate from a flow circuit of the diluted liquid absorbent for conveying the cooling medium.

41. The device according to claim 36, wherein the device includes at least one buffer for the cooling medium downstream of the at least one device for large-area contacting of the heated cooling medium with the ambient air.

42. The device according to claim 36, wherein the device includes means for controlling conveyance of the cooling medium in a predetermined time interval.

43. The device according to claim 36, wherein the device includes at least one device for removing desorbed water from a system circuit.

44. The device according to claim 36, wherein the at least one device for large-area contacting of the heated cooling medium with the ambient air includes at least one spray nozzle and/or at least one honeycomb structure and/or at least one absorption structure and/or at least one plate structure.
